(19) United States
(12) Patent Application Publication
(10) Pub. No.: US 2026/0252086 A1
(43) Pub. Date: Aug. 27, 2026

(54) FIXTURE IDENTIFICATION DEVICE, FIXTURE IDENTIFICATION SYSTEM, AND FIXTURE IDENTIFICATION METHOD

(71) Applicant: NEC Corporation, Tokyo (JP)

(72) Inventor: Manabu NAKANOYA, Tokyo (JP)

(73) Assignee: NEC Corporation, Tokyo (JP)

(21) Appl. No.: 19/455,066

(22) Filed: Jan. 21, 2026

(30) Foreign Application Priority Data
Feb. 21, 2025 (JP) 2025-026450

(51) Int. Cl. G05D 1/246; G05D 1/243; G05D 111/10

(52) U.S. Cl. CPC G05D 1/246; G05D 1/2435; G05D 2111/10

(57) ABSTRACT

A fixture identification device includes: one or more memories storing instructions; and one or more processors configured to execute the instructions to: acquire a two-dimensional map indicating position information on obstacles including a fixture of a store and three-dimensional data indicating position information on the fixture; identify an installation position of the fixture in the store based on the two-dimensional map and the three-dimensional data; and output information on the installation position.

This application is based upon and claims the benefit of priority from Japanese Patent Application No. 2025-026450, filed on Feb. 21, 2025, the disclosure of which is incorporated herein in its entirety by reference.

### TECHNICAL FIELD

The present disclosure relates to a fixture identification device and the like.

### BACKGROUND ART

JP 2020-166578 A discloses a technique for creating layout information indicating a position of a gondola fixture in a store from an imaging device capable of capturing overhead images of an inside of the store where the gondola fixture is arranged, based on position information on the gondola fixture in the images captured by the imaging device and position information on the imaging device identified by imaging device identification information.

### SUMMARY

An example of the object of the present disclosure is to provide a fixture identification device or the like capable of improving accuracy of identifying position of the fixture.

In order to solve the problem described above, a fixture identification device according to the present disclosure includes: an acquisition means for acquiring a two-dimensional map indicating position information on obstacles including a fixture of a store and three-dimensional data indicating position information on the fixture; an identification means for identifying an installation position of the fixture in the store based on the two-dimensional map and the three-dimensional data; and an output means for outputting information on the installation position.

A fixture identification method according to the present disclosure includes causing a computer to perform processing including: acquiring a two-dimensional map indicating position information on obstacles including a fixture of a store and three-dimensional data indicating position information on the fixture; identifying an installation position of the fixture in the store based on the two-dimensional map and the three-dimensional data; and outputting information on the installation position.

A program according to the present disclosure causes a computer to perform processing including: acquiring a two-dimensional map indicating position information on obstacles including a fixture of a store and three-dimensional data indicating position information on the fixture; identifying an installation position of the fixture in the store based on the two-dimensional map and the three-dimensional data; and outputting information on the installation position.

### BRIEF DESCRIPTION OF THE DRAWINGS

FIG. 1 is a diagram illustrating an example of a configuration of a fixture identification system according to the present disclosure;

FIG. 2 is a diagram illustrating an example of a configuration of a fixture identification device according to the present disclosure;

FIG. 3 is a diagram for describing a method for identifying an installation position of a fixture according to the present disclosure;

FIG. 4 is a diagram for describing the method for identifying the installation position of the fixture according to the present disclosure;

FIG. 5 is a diagram for describing the method for identifying the installation position of the fixture according to the present disclosure;

FIG. 6 is a diagram for describing the method for identifying the installation position of the fixture according to the present disclosure;

FIG. 7 is a diagram illustrating an example of an operation flow of the fixture identification device according to the present disclosure; and

FIG. 8 is a diagram illustrating an example of a configuration of hardware according to the present disclosure.

### EXAMPLE EMBODIMENT

Hereinafter, with reference to the drawings, description will be given of an example embodiment of a fixture identification device, a fixture identification method, a program, and a non-transitory recording medium for recording the program according to the present disclosure. Each present example embodiment does not limit the disclosed technique.

### First Example Embodiment

In a first example embodiment, an example of basic functions of a fixture identification device will be described in detail with reference to the drawings.

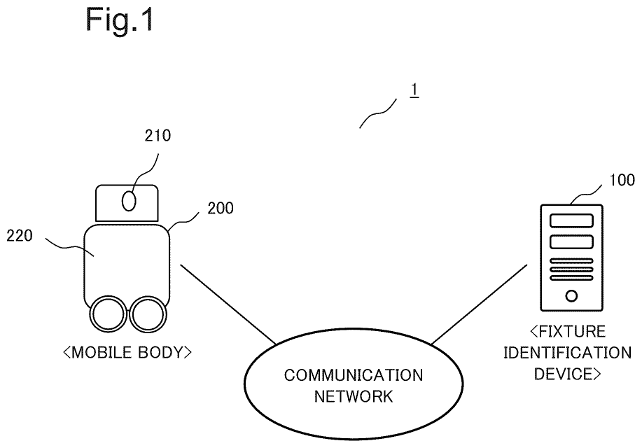

FIG. 1 is an explanatory drawing illustrating an example of a fixture identification system 1 including a fixture identification device 100. The fixture identification system 1 includes, for example, a fixture identification device 100 and a mobile body 200. The mobile body 200 includes a sensor 210 that senses fixtures in a store and a generation means 220 for generating three-dimensional data from sensing information.

The fixture identification device 100 is connected to the mobile body 200 via a communication network. A type of communication network is not particularly limited and may be a wired or wireless network. The communication network may be constituted by multiple communication networks. The configuration of the communication network by which the fixture identification device 100 is connected to the mobile body 200 and the like is not particularly limited.

The mobile body 200 may be, for example, a device that can move in a facility such as a warehouse or a store. The mobile body 200 may be, for example, a mobile robot capable of autonomous travel, or a drone. The type of the mobile body 200 is not particularly limited. The sensor 210 can move along with the movement of the mobile body 200. The fixture identification device 100 is capable of controlling the mobile body 200. A position of the sensor 210 can be changed by changing a position of the mobile body 200. In the present disclosure, an installation position of the fixture is identified by a relative position with respect to the sensor 210.

A type of the sensor 210 is not particularly limited as long as shapes of obstacles and the like in the store can be acquired by point cloud data that is aggregate of points. The sensor 210 may be, for example, constituted by a light detection and ranging (LiDAR) or an imaging device. The sensor 210 generates point cloud data indicating a distance to the fixture as a distance value for each coordinate. The point cloud data is data indicating a set of points in a three-dimensional space including a depth direction, a width direction, and a height direction, and each point can be represented by coordinates (x, y, and z).

The generation means 220 is a means for identifying the position of the mobile body 200 and generating three-dimensional data of a fixture based on a relative position with respect to the mobile body 200. In a case where the sensor 210 is a LiDAR, the generation means 220 may identify the position of the mobile body 200 using simultaneous localization and mapping (SLAM) technology based on the sensing information acquired by the LiDAR. Methods by which the generation means 220 identifies the position of the mobile body 200 are not limited to the SLAM technology. The generation means 220 may identify the position of the mobile body 200 by tracking the position of the mobile body 200 using a camera or a sensor installed on a ceiling or a wall, for example. Alternatively, the generation means 220 may identify the position of the mobile body 200 by a technique in which a magnetic tape or an optical marker is disposed on a floor surface, and the magnetic tape or the optical marker is detected by a magnetic sensor or a camera mounted on the mobile body 200 to identify the position and a traveling direction of the mobile body 200.

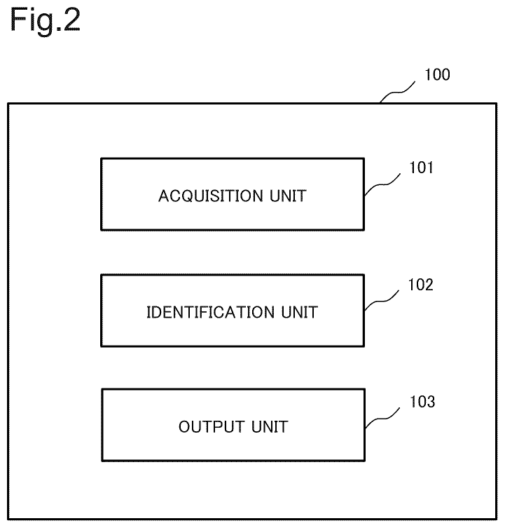

Here, an example of a configuration of the fixture identification device 100 will be described. FIG. 2 is a diagram illustrating an example of the configuration of the fixture identification device 100. The fixture identification device 100 includes an acquisition unit 101, an identification unit 102, and an output unit 103 as a basic configuration.

The acquisition unit 101 is a unit that acquires a two-dimensional map indicating position information on the obstacles including the fixture of the store and three-dimensional data indicating position information on the fixtures. The two-dimensional map is, for example, a map that displays the positions of the obstacles of the store acquired by the mobile body 200 using the SLAM technology. The obstacles include a wall, a column, and the like, in addition to a fixture. The acquisition unit 101 acquires, for example, a two-dimensional map stored in a database (not illustrated) or a storage unit of the mobile body 200. Similarly, the acquisition unit 101 acquires three-dimensional data from the database or the storage unit, for example.

The identification unit 102 is a unit that identifies the installation position of the fixture in the store based on the two-dimensional map and the three-dimensional data. For example, the identification unit 102 identifies, as the installation position of the fixture, a position where a candidate position where the fixture is estimated to be installed based on the two-dimensional map coincides with a candidate position where the fixture is estimated to be installed based on the three-dimensional data.

The identification unit 102 recognizes geometric shapes on the two-dimensional map using an image processing technology. The identification unit 102 then identifies a region where the fixture can be arranged as a candidate position based on the size of the fixture, in consideration of a space constraint such as a wall or a passage.

The identification unit 102 analyzes the three-dimensional data and identifies a position of an object estimated to be the fixture. The identification unit 102 identifies as position information, for example, three-dimensional coordinates of an outer frame (a box) of the fixture and center position of the fixture. When the position of the fixture is identified from three-dimensional point cloud data, the point cloud data may be partially missing. In this case, it may not be possible to accurately grasp the position information on the detected fixture. Therefore, the present disclosure identifies an accurate position of the fixture using information on the candidate position where the fixture can be arranged on the two-dimensional map.

For example, the identification unit 102 may detect the fixture using a learning model that has learned a correlation between the three-dimensional data and a type of the fixture, and classify the detected fixture. The classification of the fixture is not particularly limited, and examples of the classification include a wall surface shelf, an island shelf (a gondola), an end cap (a terminal display shelf), a hanging type, and the like.

This learning model is, for example, a three-dimensional convolutional neural network using a deep learning technique. This learning model is trained in advance using multiple pieces of three-dimensional point cloud data and labels of related fixture types. Characteristic shapes and dimensions of various fixtures can be learned in the learning process allowing the fixture to be detected and classified from new point cloud data.

The identification unit 102 may identify a posture of the fixture at the installation position using a learning model that has learned a correlation between the three-dimensional data and the posture of the fixture. The learning model in this case is, for example, a model which outputs directions of a boundary box of the fixture and a front surface of the fixture when inputting point cloud data indicating a set of points in a three-dimensional space including a depth direction, a width direction, and a height direction and a rotation angle of the fixture in the height direction.

The output unit 103 is a unit that outputs information on the installation position to a terminal device or the like used by a user of the fixture identification device 100. The output unit 103 may, for example, display an identified installation position of the fixture on a map of the store. When the information on the installation position includes the type or the posture of the fixture, the output unit 103 may display the information on the type or the posture of the fixture on the map.

The output unit 103 may display, on a same screen or on different screens, a candidate position where the fixture is estimated to be installed based on the two-dimensional map and a candidate position where the fixture is estimated to be installed based on the three-dimensional data. The output unit 103 may highlight a position where the candidate position where the fixture is estimated to be installed based on the two-dimensional map coincides with the candidate position where the fixture is estimated to be installed based on the three-dimensional data.

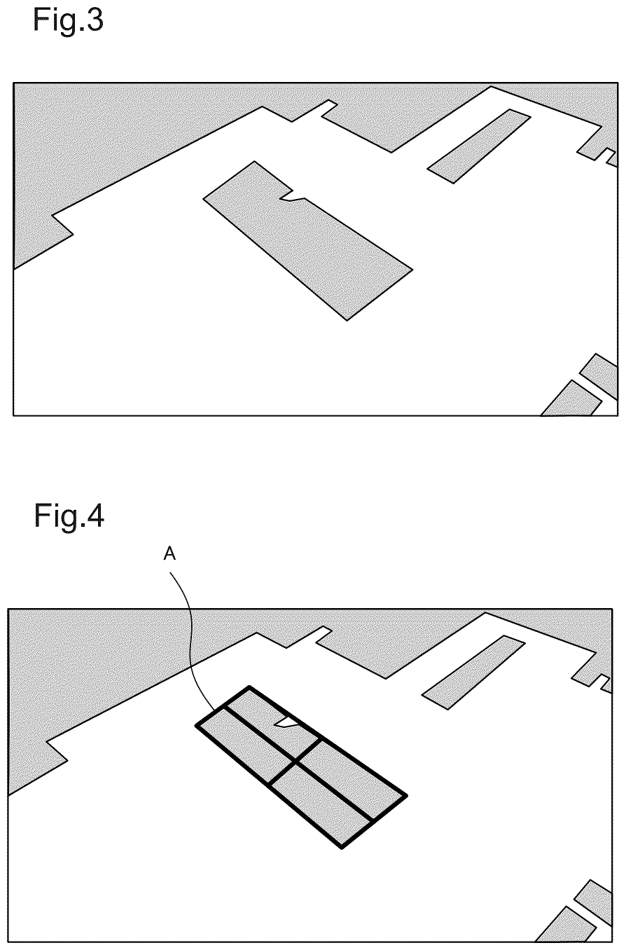

Here, a method of identifying the installation position of the fixture will be described with reference to the drawings. FIGS. 3 to 6 are diagrams for describing the method for identifying the installation position of the fixture according to the present disclosure. FIG. 3 is a schematic diagram illustrating a two-dimensional map. As illustrated in FIG. 3, portions where the obstacles including the fixture are detected are painted. FIG. 4 is a diagram illustrating the candidate position where the fixture is estimated to be installed on the two-dimensional map. In the example of FIG. 4, as illustrated by A, it is estimated that four fixtures are installed on an island display in a central portion as a candidate position where the fixtures are estimated to be installed.

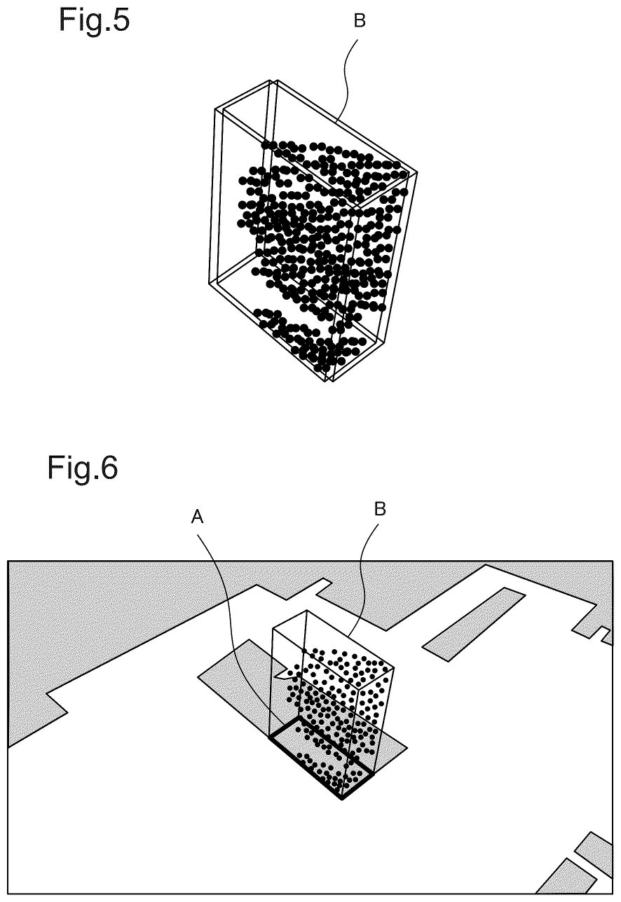

FIG. 5 is a schematic view illustrating three-dimensional data indicating positional information on the fixture. FIG. 5 illustrates candidate positions of the fixture obtained from the three-dimensional data, and illustrates point cloud data and boxes of the fixture estimated from the point cloud data. In the example of FIG. 5, multiple candidate positions of the fixture estimated from the point cloud data are illustrated. As illustrated in FIG. 5, the accurate position of the fixture cannot be identified only by the point cloud data, and multiple candidate positions of the fixture may be displayed.

FIG. 6 illustrates a screen on which the installation position of the fixture is identified. In the example of FIG. 6, a position where the candidate position where the fixture is estimated to be installed based on the two-dimensional map A coincides with the candidate position where the fixture is estimated to be installed based on the three-dimensional data B is identified as the installation position of the fixture, and the identified installation position is displayed on the screen.

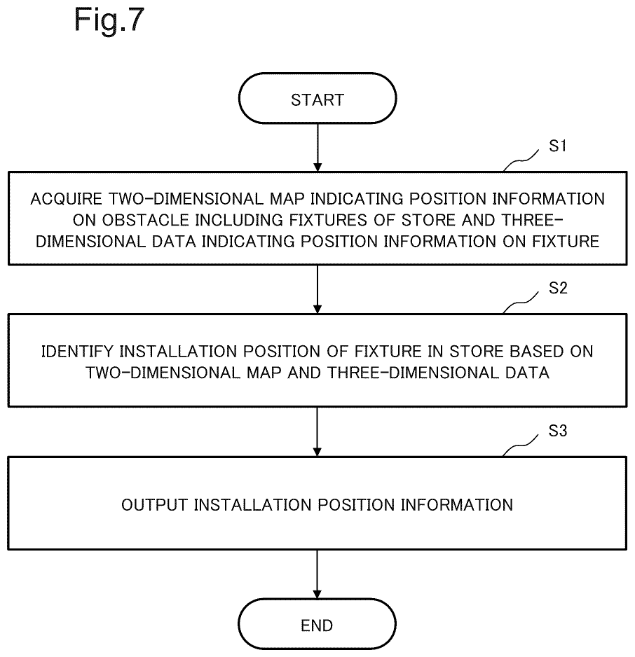

FIG. 7 illustrates an example of an operation flow of processing of identifying the position of the fixture in the fixture identification device 100. An operation of the fixture identification device 100 will be described with reference to FIG. 7.

The acquisition unit 101 acquires a two-dimensional map indicating position information on the obstacles including the fixture of the store and three-dimensional data indicating position information on the fixtures (step S1). Next, the identification unit 102 identifies the installation position of the fixture in the store based on the two-dimensional map and the three-dimensional data (step S2). Finally, the output unit 103 outputs the information on the installation positions (step S3).

When the position of the fixture is identified from two-dimensional map, it may not be possible to determine whether the object is a fixture or an obstacle other than a fixture. When the position of the fixture is identified from the three-dimensional data, the three-dimensional data is partially missing, and it may not be possible to grasp the accurate position of the fixture. The fixture identification device 100 identifies the installation position of the fixture in the store based on the two-dimensional map indicating the position information on the obstacles including the fixture of the store and the three-dimensional data indicating position information on the fixture. It is thus possible to improve accuracy of identifying the position of the fixture.

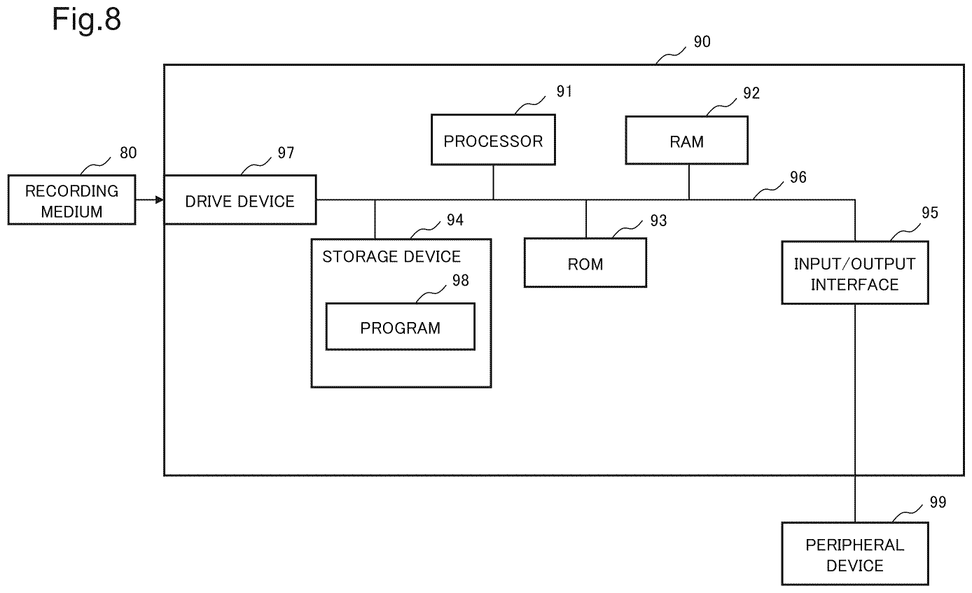

Each processing in the fixture identification device 100 can be enabled by executing a computer program on a computer device. FIG. 8 is a block diagram illustrating an example of a hardware configuration of a computer device constituting the fixture identification device 100 according to each example embodiment. In a computer device 90, the fixture identification device and the fixture identification method described in the example embodiments are implemented. For example, the fixture identification device 100 and the like described in the example embodiment may have the hardware configuration illustrated in FIG. 8.

As illustrated in FIG. 8, the computer device 90 includes a processor 91, a random access memory (RAM) 92, a read only memory (ROM) 93, a storage device 94, an input/output interface 95, a bus 96, and a drive device 97. The fixture identification device and the like may be achieved by multiple electric circuits.

The storage device 94 stores a program (a computer program) 98. The processor 91 executes the program 98 of the fixture identification device 100 using the RAM 92. Specifically, for example, the program 98 includes a program that causes a computer to execute the processing illustrated in FIG. 7 and the like, for example. When the processor 91 executes the program 98, the function of each configuration of the fixture identification device 100 is implemented. The program 98 may be stored in the ROM 93. The program 98 may be recorded in a recording medium 80 and read by the drive device 97, or may be transmitted from an external device (not illustrated) to the computer device 90 via a network (not illustrated).

The input/output interface 95 exchanges data with a peripheral device (such as a keyboard, a mouse, or a display device) 99. The input/output interface 95 functions as a means for acquiring or displaying data. The bus 96 connects the components with each other.

There are various modifications of the method of achieving the fixture identification device 100. For example, each configuration included in the fixture identification device 100 can be achieved as a dedicated device. The fixture identification device can be achieved based on a combination of multiple devices.

A processing method for causing a recording medium to record a program for implementing each component in the function of each example embodiment, reading the program recorded in the recording medium as a code, and causing a computer to execute the program is also included in the scope of each example embodiment. That is, a computer-readable recording medium is also included in the scope of each example embodiment. The recording medium recording the above-described program and the program itself are also included in each example embodiment.

The recording medium is, for example, a floppy (registered trademark) disk, a hard disk, an optical disk, a magneto-optical disk, a compact disc (CD)-ROM, a magnetic tape, a nonvolatile memory card, or a ROM, but is not limited to these examples. The program recorded in the recording medium is not limited to a program for executing processing by itself, and programs that run on an operating system (OS) to execute processing in cooperation with other software and functions of an extension board are also included in the scope of each example embodiment.

While the disclosure of the present application has been described with reference to the example embodiments, the disclosure of the present application is not limited to these example embodiments. It will be understood by those of ordinary skill in the art that various changes in form and details may be made therein without departing from the spirit and scope of the disclosure of the present application as defined by the claims.

Some or all of the example embodiments described above may also be described as, but are not limited to, the following Supplementary Notes.

### Supplementary Note 1

A fixture identification device including:
an acquisition means for acquiring a two-dimensional map indicating position information on obstacles including a fixture of a store and three-dimensional data indicating position information on the fixture;
an identification means for identifying an installation position of the fixture in the store based on the two-dimensional map and the three-dimensional data; and
an output means for outputting information on the installation position.

### Supplementary Note 2

The fixture identification device according to supplementary note 1, wherein
the identification means identifies, as the installation position of the fixture, a position where a candidate position where the fixture is estimated to be installed based on the two-dimensional map coincides with a candidate position where the fixture is estimated to be installed based on the three-dimensional data.

### Supplementary Note 3

The fixture identification device according to supplementary note 2, wherein
the output means displays, on the same screen, a candidate position where the fixture is estimated to be installed based on the two-dimensional map and a candidate position where the fixture is estimated to be installed based on the three-dimensional data.

### Supplementary Note 4

The fixture identification device according to supplementary note 1, wherein
the three-dimensional data is data acquired by a sensor mounted on a mobile body that goes around the store.

### Supplementary Note 5

The fixture identification device according to supplementary note 1, wherein
the identification means identifies a type of the fixture at the installation position using a learning model that has learned a correlation between the three-dimensional data and a type of the fixture.

### Supplementary Note 6

The fixture identification device according to supplementary note 1, wherein
the identification means identifies a posture of the fixture at the installation position using a learning model that has learned a correlation between the three-dimensional data and the posture of the fixture.

### Supplementary Note 7

A fixture identification system including:
the fixture identification device according to any one of supplementary notes 1 to 6 and a mobile body, wherein
the mobile body includes a sensor that senses a fixture in a store and a generation means for generating the three-dimensional data from sensing information; and
the generation means identifies a position of the mobile body and generates the three-dimensional data of the fixture based on a relative position with respect to the mobile body.

### Supplementary Note 8

A fixture identification system according to supplementary note 7, wherein
the sensor is a light detection and ranging (LiDAR), and
the generation means identifies a position of the mobile body using simultaneous localization and mapping (SLAM) technology based on the sensing information acquired by the LiDAR.

### Supplementary Note 9

A fixture identification method including causing a computer to perform processing including:
acquiring a two-dimensional map indicating position information on obstacles including a fixture of a store and three-dimensional data indicating position information on the fixture;
identifying an installation position of the fixture in the store based on the two-dimensional map and the three-dimensional data; and
outputting information on the installation position.

### Supplementary Note 10

A program for causing a computer to perform processing including:
acquiring a two-dimensional map indicating position information on obstacles including a fixture of a store and three-dimensional data indicating position information on the fixture;
identifying an installation position of the fixture in the store based on the two-dimensional map and the three-dimensional data; and
outputting information on the installation position.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as Supplementary Notes can be similarly dependent on not only Supplementary Notes 1, 9, and 10, but also diverse pieces of hardware and software, various recording means for recording software, or systems without departing from the above-described example embodiments.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure. And each embodiment can be appropriately combined with other embodiments.

There is a technique of collecting photographed images and sensor data in stores and identifying rough positions of passages and fixtures in the stores.

In order to estimate shelf allocation of fixtures such as product shelves, it is required to identify more accurate positions of the fixtures.

An example of the effect of the present disclosure is capable of improving accuracy of identifying the position of the fixture.

1. A fixture identification device comprising:
one or more memories storing instructions; and
one or more processors configured to execute the instructions to:
acquire a two-dimensional map indicating position information on obstacles including a fixture of a store and three-dimensional data indicating position information on the fixture;
identify an installation position of the fixture in the store based on the two-dimensional map and the three-dimensional data; and
output information on the installation position.

2. The fixture identification device according to claim 1, wherein the one or more processors are configured to execute the instructions to:
identify, as the installation position of the fixture, a position where a candidate position where the fixture is estimated to be installed based on the two-dimensional map coincides with a candidate position where the fixture is estimated to be installed based on the three-dimensional data.

3. The fixture identification device according to claim 2, wherein the one or more processors are configured to execute the instructions to:
display, on the same screen, a candidate position where the fixture is estimated to be installed based on the two-dimensional map and a candidate position where the fixture is estimated to be installed based on the three-dimensional data.

4. The fixture identification device according to claim 1, wherein
the three-dimensional data is data acquired by a sensor mounted on a mobile body that goes around the store.

5. The fixture identification device according to claim 1, wherein the one or more processors are configured to execute the instructions to:
identify a type of the fixture at the installation position using a learning model that has learned a correlation between the three-dimensional data and a type of the fixture.

6. The fixture identification device according to claim 1, wherein the one or more processors are configured to execute the instructions to:
identify a posture of the fixture at the installation position using a learning model that has learned a correlation between the three-dimensional data and the posture of the fixture.

7. A fixture identification system comprising:
the fixture identification device according to claim 1; and
a mobile body, wherein the mobile body includes:
a sensor that senses a fixture in a store;
one or more memories storing instructions; and
one or more processors configured to execute the instructions to:
identify a position of the mobile body using sensing information acquired by the sensor; and
generate the three-dimensional data of the fixture based on a relative position with respect to the mobile body.

8. A fixture identification system according to claim 7, wherein
the sensor is a light detection and ranging (LiDAR), and
the one or more processors included in the mobile body are configured to execute the instructions to:
identify a position of the mobile body using simultaneous localization and mapping (SLAM) technology based on the sensing information acquired by the LiDAR.

9. A fixture identification method comprising causing a computer to perform processing including:
acquiring a two-dimensional map indicating position information on obstacles including a fixture of a store and three-dimensional data indicating position information on the fixture;
identifying an installation position of the fixture in the store based on the two-dimensional map and the three-dimensional data; and
outputting information on the installation position.
